(19) United States
(12) Patent Application Publication
(10) Pub. No.: US 2026/0036204 A1
(43) Pub. Date: Feb. 5, 2026

(54) ABS TONE WHEEL INTEGRATED UNITIZED LIP SEAL

(71) Applicant: Schaeffler Technologies AG & Co. KG, Herzogenaurach (DE)

(72) Inventors: Dalal Almahd, Fairlawn, OH (US); Gregory Heeke, Wooster, OH (US); Scott Angel, Marshallville, OH (US); Nicholas Crane, Macedonia, OH (US)

(21) Appl. No.: 18/793,207

(22) Filed: Aug. 2, 2024

(51) Int. Cl. F16J 15/3204; B60B 35/00; G01P 3/481

(52) U.S. Cl. CPC F16J 15/3204; B60B 35/004; G01P 3/481; B60B 2900/212; B60B 2900/325; B60B 2900/5112

(57) ABSTRACT

A sealing device may include the tone wheel and a lip seal which are coupled together. The sealing device may also include an over-mold chamfer coupled to the tone wheel. The tone wheel may include a wheel outer axial portion defining axial slots. An axle assembly may include a sensor which sense the axial slots. The lip seal may include an outer ring, a carrier coupled to the tone wheel, a garter spring, a spring gasket coupled to the garter spring and sealing the outer ring and the carrier, a carrier gasket sealing the outer ring and the carrier, and an insert.

### TECHNICAL FIELD

The present disclosure generally relates to rotating shafts, and more particularly, to seals for rotating shafts.

### BACKGROUND

A wheel speed is used for feedback control of an anti-lock brake system (ABS). Wheel speed sensors are used to determine the wheel speed. Brake packages of the wheel may generate heat and metallic debris. The heat and/or metallic debris from the brake packages may damage or foul the wheel speed sensors. Therefore, it would be advantageous to provide a device, system, and method that cures the shortcomings described above.

### SUMMARY

A sealing device is described, in accordance with one or more embodiments of the present disclosure. The sealing device may include: a tone wheel including a wheel inner axial portion, a wheel radial portion, and a wheel outer axial portion, wherein the wheel radial portion couples between the wheel inner axial portion and the wheel outer axial portion, wherein the wheel inner axial portion and the wheel outer axial portion axially extend from the wheel radial portion in opposing directions, wherein the wheel outer axial portion defines a plurality of axial slots; an over-mold chamfer, wherein the over-mold chamfer is coupled to the wheel inner axial portion and the wheel radial portion; and a lip seal, wherein the wheel inner axial portion is coupled to the lip seal, wherein the wheel inner axial portion is disposed radially inwards of and axially aligned with the lip seal.

In some aspects, the tone wheel, the over-mold chamfer, and the lip seal are coincident.

In some aspects, the plurality of axial slots are defined in a polar array.

In some aspects, the over-mold chamfer includes a mold ribbed portion and a mold chamfered portion, wherein the mold ribbed portion couples to the wheel inner axial portion, wherein the mold chamfered portion couples to the wheel radial portion.

In some aspects, the mold ribbed portion is disposed radially inwards of and axially aligned with the wheel inner axial portion.

In some aspects, the mold chamfered portion is radially aligned with and disposed axially offset from the wheel radial portion, wherein the mold chamfered portion is disposed radially inwards of and axially aligned with the wheel outer axial portion.

In some aspects, the mold ribbed portion includes a plurality of ribs, wherein the plurality of ribs are circumferentially revolved.

In some aspects, the mold chamfered portion flares radially outwards along an axial length of the mold chamfered portion away from the mold ribbed portion.

In some aspects, the wheel outer axial portion is disposed radially outwards of and axially offset from the lip seal.

In some aspects, the tone wheel includes a ferromagnetic material.

In some aspects, the lip seal includes: an outer ring; a carrier, wherein the carrier couples the lip seal to the tone wheel; a garter spring; a spring gasket, wherein the garter spring is coupled to the spring gasket, wherein the spring gasket seals the outer ring and the carrier; a carrier gasket, wherein the carrier gasket seals the outer ring and the carrier; and an insert, wherein the carrier and the carrier gasket are configured to axially translate between the outer ring and the insert, wherein the lip seal is a dynamic seal.

In some aspects, the outer ring, the spring gasket, the garter spring, the carrier, the carrier gasket, and the insert are coincident.

In some aspects, the outer ring includes a ring inner radial portion, a ring axial portion, and a ring outer radial portion, wherein the ring inner radial portion and the ring outer radial portion extend radially inwards from opposing ends of the ring axial portion; wherein the carrier includes a carrier inner axial portion, a carrier inner radial portion, a carrier outer axial portion, and a carrier outer radial portion, wherein the carrier inner axial portion and the carrier outer axial portion axially extend in a same direction from opposing ends of the carrier inner radial portion, wherein the carrier inner radial portion and the carrier outer radial portion radially extend in opposing directions from opposing ends of the carrier outer axial portion; wherein the spring gasket includes a seal radial portion and a seal first lip portion.

In some aspects, the garter spring causes the seal first lip portion to seal to the carrier inner axial portion, wherein the spring gasket couples between the ring inner radial portion and the carrier inner axial portion.

In some aspects, the spring gasket, the garter spring, the carrier, the carrier gasket, and the insert are disposed radially inwards of the ring axial portion, wherein the insert is radially aligned with and axially disposed between the carrier gasket and the ring inner radial portion.

In some aspects, the insert includes an insert axial portion and an insert radial portion, wherein the insert radial portion extends radially inwards from the insert axial portion, wherein the insert axial portion is configured to abut the ring inner radial portion, wherein the insert radial portion is configured to abut the carrier gasket.

An axle assembly is described, in accordance with one or more embodiments of the present disclosure. The axle assembly may include: a sealing device including: a tone wheel including a wheel inner axial portion, a wheel radial portion, and a wheel outer axial portion, wherein the wheel radial portion couples between the wheel inner axial portion and the wheel outer axial portion, wherein the wheel inner axial portion and the wheel outer axial portion axially extend from the wheel radial portion in opposing directions, wherein the wheel outer axial portion defines a plurality of axial slots; an over-mold chamfer, wherein the over-mold chamfer is coupled to the wheel inner axial portion and the wheel radial portion; and a lip seal, wherein the wheel inner axial portion is coupled to the lip seal, wherein the wheel inner axial portion is disposed radially inwards of and axially aligned with the lip seal; an axle shaft, wherein the over-mold chamfer is coupled to an outer diameter of the axle shaft; an axle housing, wherein the lip seal seals the axle shaft to the axle housing; and a sensor, wherein the sensor is coupled to the axle housing, wherein the sensor is disposed radially outwards of and axially aligned with the plurality of axial slots, wherein the sensor is configured to sense rotation of the axle shaft via the plurality of axial slots.

In some aspects, the over-mold chamfer includes a mold ribbed portion and a mold chamfered portion, wherein the mold ribbed portion couples to the wheel inner axial portion, wherein the mold chamfered portion couples to the wheel radial portion.

In some aspects, the mold ribbed portion includes a plurality of ribs, wherein the plurality of ribs are circumferentially revolved; wherein the plurality of ribs deform to seal the sealing device to the axle shaft.

A lip seal is described, in accordance with one or more embodiments of the present disclosure. The lip seal may include: an outer ring, wherein the outer ring includes a ring inner radial portion, a ring axial portion, and a ring outer radial portion, wherein the ring inner radial portion and the ring outer radial portion extend radially inwards from opposing ends of the ring axial portion; a carrier, wherein the carrier includes a carrier inner axial portion, a carrier inner radial portion, a carrier outer axial portion, and a carrier outer radial portion, wherein the carrier inner axial portion and the carrier outer axial portion axially extend in a same direction from opposing ends of the carrier inner radial portion, wherein the carrier inner radial portion and the carrier outer radial portion radially extend in opposing directions from opposing ends of the carrier outer axial portion; a garter spring; a spring gasket, wherein the garter spring is coupled to the spring gasket, wherein the spring gasket seals the outer ring and the carrier, wherein the spring gasket includes a seal radial portion and a seal first lip portion; a carrier gasket, wherein the carrier gasket seals the outer ring and the carrier; and an insert, wherein the carrier and the carrier gasket are configured to axially translate between the outer ring and the insert, wherein the lip seal is a dynamic seal.

### BRIEF DESCRIPTION OF THE DRAWINGS

The numerous advantages of the disclosure may be better understood by those skilled in the art by reference to the accompanying figures in which:

FIG. 1A depicts a front-perspective view of a sealing device, in accordance with one or more embodiments of the present disclosure.

FIG. 1B depicts a front-perspective section view of the sealing device, in accordance with one or more embodiments of the present disclosure.

FIG. 1C depicts a side view of the sealing device, in accordance with one or more embodiments of the present disclosure.

FIG. 1D depicts a side section view of the sealing device, in accordance with one or more embodiments of the present disclosure.

FIG. 1E depicts a rear-perspective view of the sealing device, in accordance with one or more embodiments of the present disclosure.

FIG. 1F depicts a rear-perspective section view of the sealing device, in accordance with one or more embodiments of the present disclosure.

FIG. 1G depicts a front exploded view of the sealing device, in accordance with one or more embodiments of the present disclosure.

FIG. 1H depicts a rear exploded view of the sealing device, in accordance with one or more embodiments of the present disclosure.

FIG. 2A depicts a front-perspective section view of a lip seal of the sealing device, in accordance with one or more embodiments of the present disclosure.

FIG. 2B depicts a partial-side section view of the lip seal, in accordance with one or more embodiments of the present disclosure.

FIG. 2C depicts a rear-perspective section view of the lip seal, in accordance with one or more embodiments of the present disclosure.

FIG. 3 depicts a side view of an axle assembly including the sealing device, in accordance with one or more embodiments of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Embodiments of the present disclosure are directed to an anti-lock brake system (ABS) tone wheel integrated unitized lip seal. A sealing device may include the tone wheel and a lip seal which are coupled together. The sealing device may also include an over-mold chamfer coupled to the tone wheel. The tone wheel may include a wheel outer axial portion defining axial slots. An axle assembly may include a sensor which sense the axial slots. The lip seal may include an outer ring, a carrier coupled to the tone wheel, a garter spring, a spring gasket coupled to the garter spring and sealing the outer ring and the carrier, a carrier gasket sealing the outer ring and the carrier, and an insert.

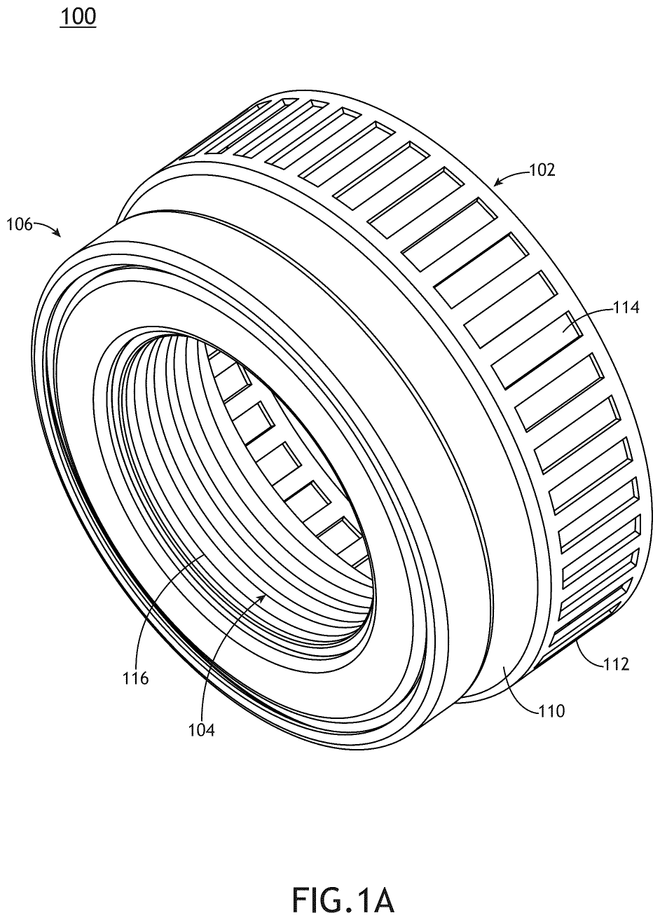

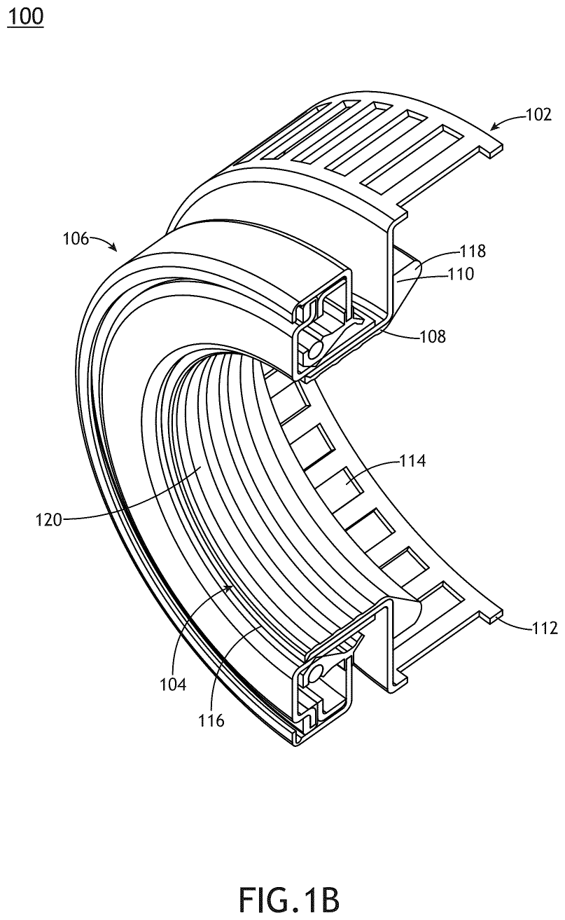

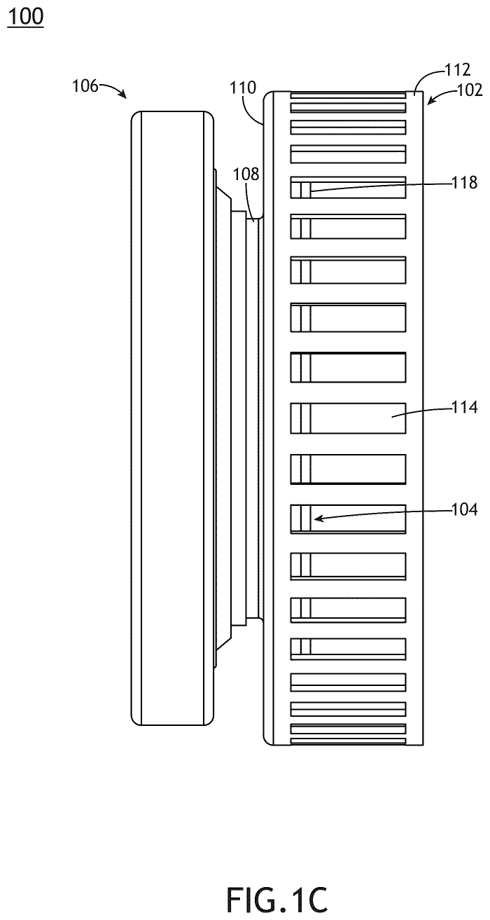

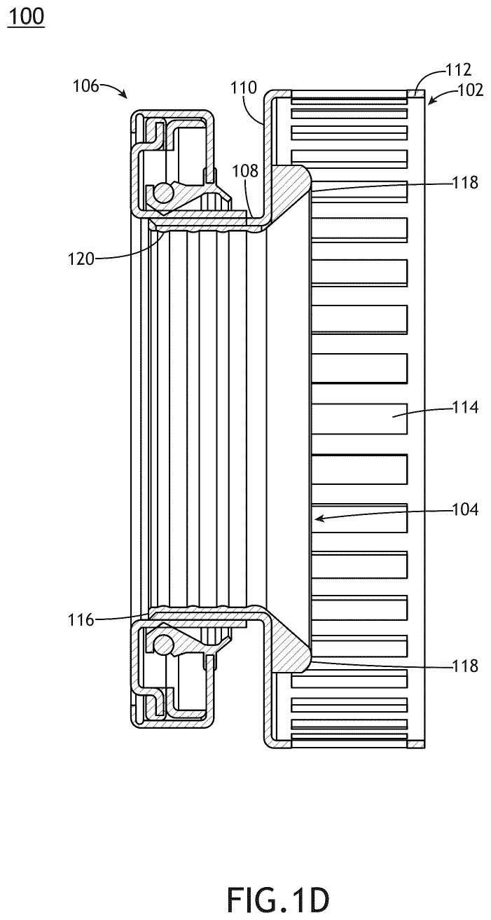

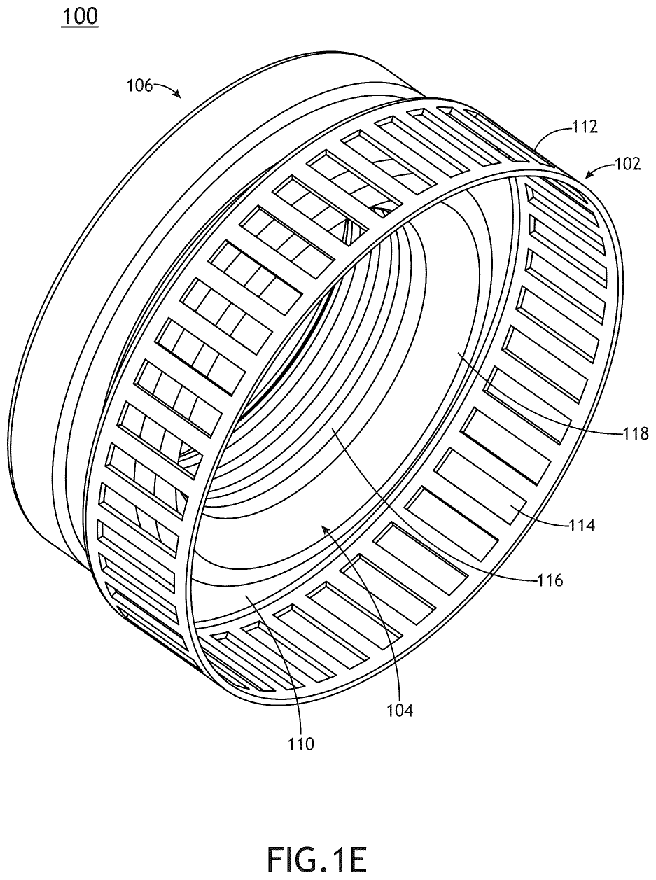

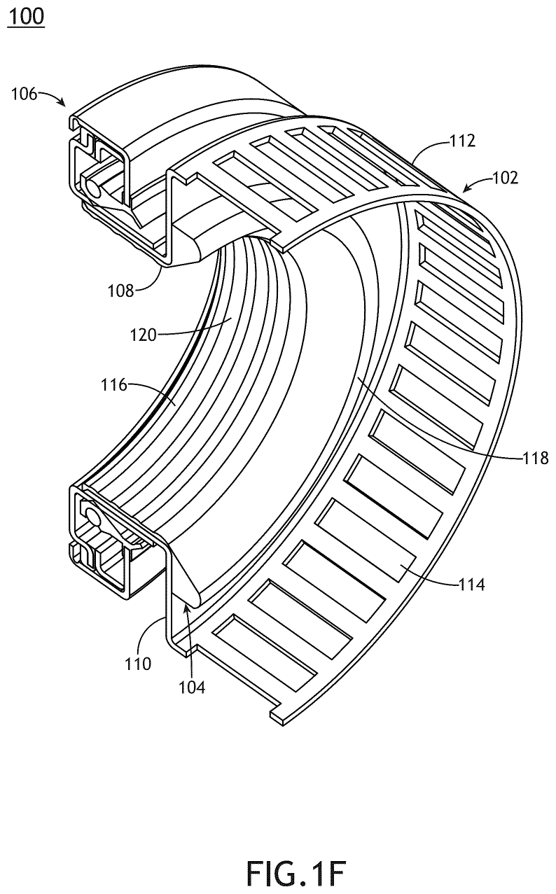

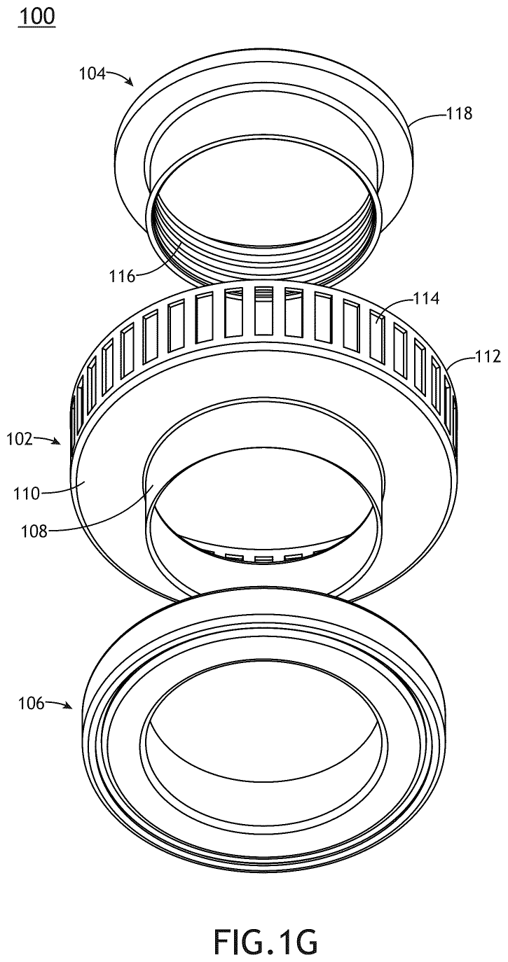

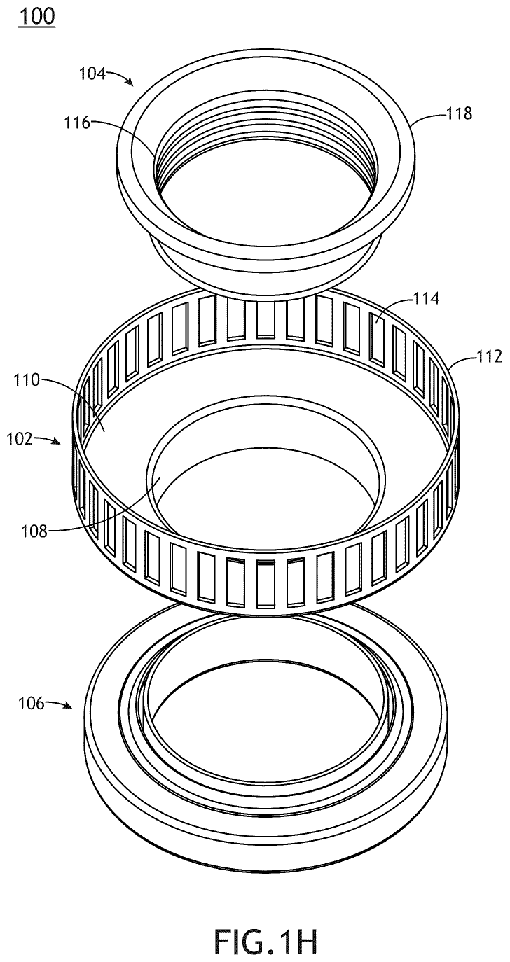

FIGS. 1A-1H depict a sealing device 100, in accordance with one or more embodiments of the present disclosure. The sealing device 100 may be for an anti-lock brake system (ABS). The sealing device 100 may include a tone wheel 102, an over-mold chamfer 104, and/or a lip seal 106.

The tone wheel 102, the over-mold chamfer 104, and/or the lip seal 106 may be coincident. The tone wheel 102, the over-mold chamfer 104, and/or the lip seal 106 may each be coincident to a center axis of the sealing device 100. For example, center axes of the tone wheel 102, the over-mold chamfer 104, and/or the lip seal 106 may each be coincident to the center axis of the sealing device 100.

The tone wheel 102, the over-mold chamfer 104, and/or the lip seal 106 may each be circumferentially revolved about the center axis. For example, the profiles of the tone wheel 102, the over-mold chamfer 104, and/or the lip seal 106 may be the same around the circumference.

The tone wheel 102 may be a pulse wheel, a tone ring, or the like. The tone wheel 102 may include a wheel inner axial portion 108, a wheel radial portion 110, and/or a wheel outer axial portion 112. The wheel inner axial portion 108 and/or the wheel outer axial portion 112 may extend axially along the center axis of the sealing device 100. The wheel radial portion 110 may extend radially from the center axis of the sealing device 100. The wheel inner axial portion 108 and the wheel outer axial portion 112 may axially extend from the wheel radial portion 110 in opposing directions. The wheel radial portion 110 may couple between the wheel inner axial portion 108 and the wheel outer axial portion 112. The wheel inner axial portion 108 may be disposed radially inwards of the wheel outer axial portion 112.

The wheel outer axial portion 112 may define axial slots 114. The axial slots 114 may also be referred to as teeth. The axial slots 114 may extend axially along the center axis of the sealing device 100. The axial slots 114 may be defined in a polar array about the center axis of the sealing device 100. The axial slots 114 may be circumferentially separated from adjacent of the axial slots 114 by a same distance when defined in the polar array.

The axial slots 114 may include a shape, such as, but not limited to, a rectangular shape, a rounded-rectangular shape, an oval shape, or the like.

The wheel outer axial portion 112 may define any number of the axial slots 114. For example, the wheel outer axial portion 112 is depicted as defining forty of the axial slots 114, although this is not intended as a limitation of the present disclosure. It is contemplated that the wheel outer axial portion 112 may define more than or less then forty of the axial slots 114.

The over-mold chamfer 104 may include a mold ribbed portion 116 and/or a mold chamfered portion 118. The mold chamfered portion 118 may extend radially outwards from an axial end of the mold ribbed portion 116.

The mold ribbed portion 116 may include ribs 120. The ribs 120 may be circumferentially revolved about the center axis of the sealing device 100. The mold ribbed portion 116 may include any number of the ribs 120. For example, the mold ribbed portion 116 is depicted with four of the ribs 120, although this is not intended as a limitation of the present disclosure. The ribs 120 may be defined in a linear array along the center axis. The ribs 120 may be axially separated from adjacent of the ribs 120 by a same distance when defined in the linear array. It is further contemplated that the ribs 120 may not be defined in the linear array while maintaining the functionality of the ribs 120.

The tone wheel 102 and over-mold chamfer 104 may be coupled. The over-mold chamfer 104 may be coupled to the wheel inner axial portion 108 and the wheel radial portion 110. The mold ribbed portion 116 and the mold chamfered portion 118 may be couple to the wheel inner axial portion 108 and the wheel radial portion 110, respectively, thereby coupling the tone wheel 102 and the over-mold chamfer 104. The mold ribbed portion 116 may be disposed radially inwards of and axially aligned with the wheel inner axial portion 108, by which the mold ribbed portion 116 may couple to the wheel inner axial portion 108. The mold chamfered portion 118 may be radially aligned with and disposed axially offset from the wheel radial portion 110, by which the mold chamfered portion 118 may couple to the wheel radial portion 110.

The mold chamfered portion 118 may be disposed radially inwards of and axially aligned with the wheel outer axial portion 112. The mold chamfered portion 118 may or may not abut the wheel outer axial portion 112. For example, the mold chamfered portion 118 is depicted as not abutting the wheel outer axial portion 112, although this is not intended as a limitation of the present disclosure.

The mold chamfered portion 118 may flare radially outwards along the axial length of the mold chamfered portion 118 away from the mold ribbed portion 116. The mold chamfered portion 118 may include a select angle at which the mold chamfered portion 118 flares radially outwards along the axial length of the mold chamfered portion 118. For example, the mold chamfered portion 118 is depicted with a forty-degree angle, although this is not intended as a limitation of the present disclosure. It is further contemplated that the flare angle of the mold chamfered portion 118 may be greater than or less than forty-degrees while maintaining the functionality of the mold chamfered portion 118.

The tone wheel 102 may be integrated and/or unitized with the lip seal 106. The tone wheel 102 and the lip seal 106 may be coupled. The wheel inner axial portion 108 may be coupled to the lip seal 106, thereby coupling the tone wheel 102 and the lip seal 106. The wheel inner axial portion 108 may be disposed radially inwards of and axially aligned with the lip seal 106, by which the wheel inner axial portion 108 may couple to the lip seal 106. The wheel radial portion 110 may be radially aligned with and axially offset from the lip seal 106. The wheel radial portion 110 may or may not abut the lip seal 106. For example, the wheel radial portion 110 is depicted as not abutting the lip seal 106, although this is not intended as a limitation of the present disclosure. The wheel outer axial portion 112 may be disposed radially outwards of, axially offset from, and without abutment to the lip seal 106.

The tone wheel 102 may couple the over-mold chamfer 104 to the lip seal 106 through the coupling between the tone wheel 102 and the over-mold chamfer 104 and through the coupling between the tone wheel 102 and the lip seal 106.

The tone wheel 102 and/or the over-mold chamfer 104 may be made of a select material. For example, the tone wheel 102 may be made of a ferromagnetic material, such as, but not limited to ferrous steel. The tone wheel 102 may be fabricated by a manufacturing process, such as, but not limited to, a stamping process. The tone wheel 102 may be stamped for cost-effective manufacturing. By way of another example, the over-mold chamfer 104 may be made of a plastic material capable of being formed by an over-molding process.

The tone wheel 102 and/or the over-mold chamfer 104 may be monolithic. In this regard, the tone wheel 102 and/or the over-mold chamfer 104 may be single pieces which are not formed of halves or other constituent pieces. The tone wheel 102 and the over-mold chamfer 104 may be separate pieces where the tone wheel 102 and the over-mold chamfer 104 are individually monolithic. The lip seal 106 may not be monolithic. For example, the lip seal 106 may be an assembly of constituent pieces.

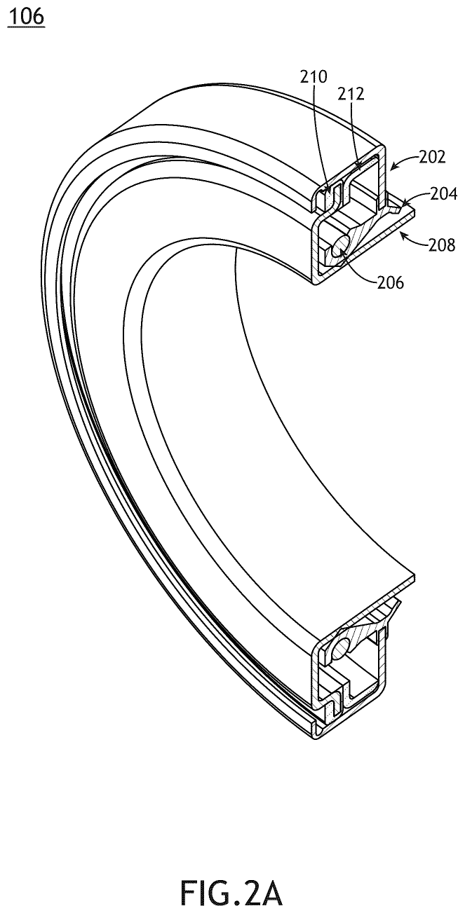

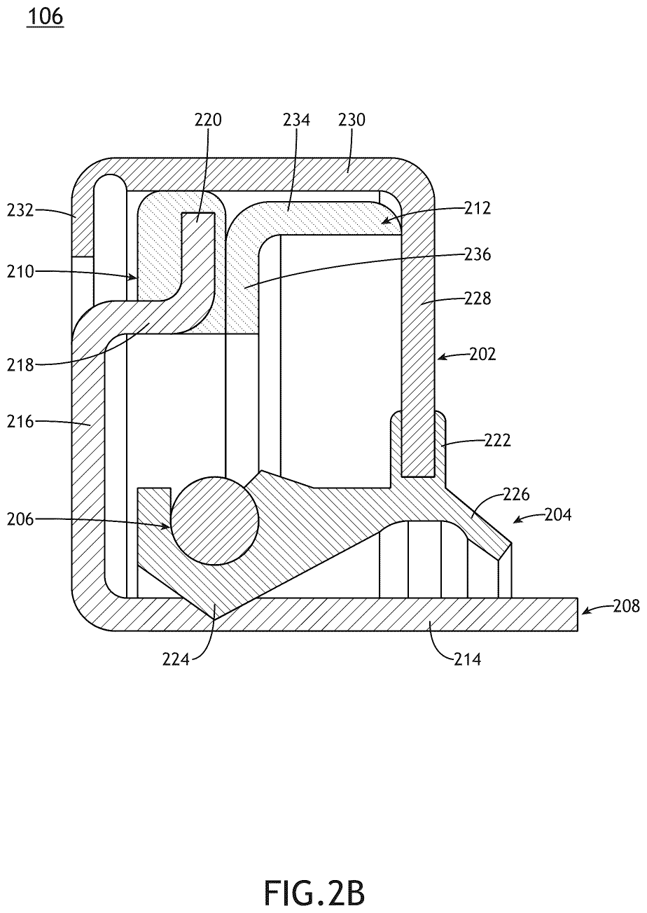

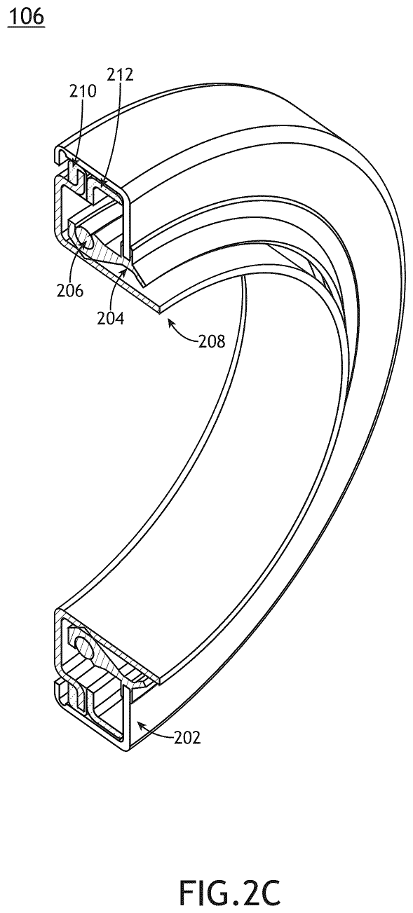

FIGS. 2A-2C depict the lip seal 106, in accordance with one or more embodiments of the present disclosure. The lip seal 106 may include an outer ring 202, a spring gasket 204, a garter spring 206, a carrier 208, a carrier gasket 210, and/or an insert 212.

The outer ring 202, the spring gasket 204, the garter spring 206, the carrier 208, the carrier gasket 210, and/or the insert 212 may each be coincident to the center axis of the lip seal 106. For example, center axes of the outer ring 202, the spring gasket 204, the garter spring 206, the carrier 208, the carrier gasket 210, and/or the insert 212 may each be coincident to the center axis of the lip seal 106.

The outer ring 202, the spring gasket 204, the garter spring 206, the carrier 208, the carrier gasket 210, and/or the insert 212 may each be circumferentially revolved about the center axis. For example, the profiles of the outer ring 202, the spring gasket 204, the garter spring 206, the carrier 208, the carrier gasket 210, and/or the insert 212 may be the same around the circumference.

The outer ring 202 may be a retaining sleeve. The outer ring 202 may include a ring inner radial portion 228, a ring axial portion 230, and/or a ring outer radial portion 232. The ring axial portion 230 may axially extend along the center axis. The ring inner radial portion 228 and/or the ring outer radial portion 232 may extend radially inwards from opposing ends of the ring axial portion 230. The ring inner radial portion 228 may be radially longer than the ring outer radial portion 232, such that the ring inner radial portion 228 and the ring outer radial portion 232 may be considered radially inner and radially outer, respectively.

The spring gasket 204, the garter spring 206, the carrier 208, the carrier gasket 210, and/or the insert 212 may be disposed radially inwards of the ring axial portion 230.

The carrier 208 may include a carrier inner axial portion 214, a carrier inner radial portion 216, a carrier outer axial portion 218, and/or a carrier outer radial portion 220.

The carrier 208 may couple the lip seal 106 to the tone wheel 102. For example, the carrier inner axial portion 214 of the carrier 208 may couple the lip seal 106 to the tone wheel 102. The carrier inner axial portion 214 of the carrier 208 may seal to the wheel inner axial portion 108 of the tone wheel 102. The carrier inner axial portion 214 and the wheel inner axial portion 108 may be sealed by an interference fit, or the like. Thus, the tone wheel 102 and the carrier 208 may be sealed together.

The carrier inner radial portion 216 may radially extend between the carrier inner axial portion 214 and the carrier outer axial portion 218. The carrier inner axial portion 214 and the carrier outer axial portion 218 may extend from opposing ends of the carrier inner radial portion 216. The carrier inner axial portion 214 and the carrier outer axial portion 218 may each extend in a same direction from the carrier inner radial portion 216. The carrier inner axial portion 214 and/or the carrier outer axial portion 218 may axially extend along the center axis. The carrier inner axial portion 214 may be disposed radially inwards of the carrier outer axial portion 218, such that the carrier inner axial portion 214 and the carrier outer axial portion 218 may be inner and outer axial portions, respectively. The carrier inner axial portion 214 and the carrier outer axial portion 218 may axially extend in a same direction from opposing ends of the carrier inner radial portion 216.

The carrier outer axial portion 218 may axially extend between the carrier inner radial portion 216 and the carrier outer radial portion 220. The carrier inner radial portion 216 and the carrier outer radial portion 220 may radially extend from opposing ends of the carrier outer axial portion 218. The carrier inner radial portion 216 and the carrier outer radial portion 220 may extend radially inwards and radially outwards, respectively, from the carrier outer axial portion 218. The carrier inner radial portion 216 may be disposed radially outwards of the carrier outer radial portion 220, such that the carrier inner radial portion 216 and the carrier outer radial portion 220 may be inner and outer radial portions, respectively. The carrier inner radial portion 216 and the carrier outer radial portion 220 may radially extend in opposing directions from opposing ends of the carrier outer axial portion 218.

The spring gasket 204 may include a seal radial portion 222, a seal first lip portion 224, and/or a seal second lip portion 226. The seal radial portion 222 may be axially disposed between the seal first lip portion 224 and the seal second lip portion 226.

The garter spring 206 may be an extension spring.

The garter spring 206 may be coupled to the spring gasket 204. The seal first lip portion 224 may receive the garter spring 206. The seal first lip portion 224 may define a cavity by which the garter spring 206 is received.

The garter spring 206 may compress the seal first lip portion 224 radially inwards. The garter spring 206 may cause the seal first lip portion 224 to seal to the carrier inner axial portion 214. The seal first lip portion 224 is depicted as protruding radially into the carrier inner axial portion 214 to indicate the force provided radially inwards by the garter spring 206, although this is not intended to be limiting. The seal first lip portion 224 may not actually protrude radially into the carrier inner axial portion 214, but may rather axially deform by the force provided radially inwards by the garter spring 206. The axial deformation may provide the seal between the seal first lip portion 224 and the carrier inner axial portion 214.

The ring inner radial portion 228 may receive the seal radial portion 222. The ring inner radial portion 228 may define a cavity by which the seal radial portion 222 is received.

The spring gasket 204 may seal the outer ring 202 and the carrier 208. The spring gasket 204 may seal the outer ring 202 and the carrier 208 by coupling between the ring inner radial portion 228 and the carrier inner axial portion 214.

The insert 212 may include an insert axial portion 234 and/or an insert radial portion 236. The insert axial portion 234 may extend axially along the center axis. The insert radial portion 236 may extend radially inwards from the insert axial portion 234.

The insert 212 may abut the outer ring 202. The insert axial portion 234 and the ring axial portion 230 may abut. An end of the insert axial portion 234 may also abut the ring inner radial portion 228.

The insert 212 may be radially aligned with and axially disposed between the carrier gasket 210 and the ring inner radial portion 228.

The insert 212 may abut between the outer ring 202 and the carrier gasket 210. The insert radial portion 236 may abut the carrier gasket 210. An end of the insert axial portion 234 opposing the insert radial portion 236 may abut the ring inner radial portion 228. The insert 212 may axially support the seal between the outer ring 202, the carrier 208, the carrier gasket 210, and the insert 212 by the abutment with the outer ring 202 and the abutment between the outer ring 202 and the carrier gasket 210.

The carrier gasket 210 may seal the outer ring 202 and the carrier 208. For example, the carrier gasket 210 may couple between the ring axial portion 230 of the outer ring 202 and the carrier outer axial portion 218 and/or the carrier outer radial portion 220 of the carrier 208. The carrier outer axial portion 218 and/or the carrier outer radial portion 220 may be received within a cavity defined by the carrier gasket 210. A radially outer face of the carrier gasket 210 may abut the ring axial portion 230.

The carrier 208 and the carrier gasket 210 may be configured to axially translate between the outer ring 202 and the insert 212. For example, the carrier 208 and the carrier gasket 210 may be configured to axially translate between the ring outer radial portion 232 of the outer ring 202 and the insert radial portion 236 of the insert 212. The ring outer radial portion 232 and the insert radial portion 236 may be dead stop plates by which the carrier 208 and the carrier gasket 210 may be stopped when subject to thrust loads along the center axis.

The lip seal 106 may be a dynamic seal. The spring gasket 204 and/or the carrier gasket 210 may maintain the seals under dynamic conditions when the lip seal 106 is subject to thrust loads along the center axis and/or while axially translating between the ring outer radial portion 232 and the insert radial portion 236. For example, the spring gasket 204 may maintain the seal between the carrier inner axial portion 214 and the ring inner radial portion 228. By way of another example, the carrier gasket 210 may maintain the seal between the carrier outer radial portion 220 and the ring axial portion 230.

The outer ring 202, the spring gasket 204, the garter spring 206, the carrier 208, the carrier gasket 210, and/or the insert 212 may be made of a select material. For example, the outer ring 202, the carrier 208, and/or the insert 212 may be made of aluminum. The outer ring 202, the carrier 208, and/or the insert 212 may be fabricated by a manufacturing process, such as, but not limited to, a stamping process. By way of another example, the spring gasket 204 and/or the carrier gasket 210 may be made of a gasket material. By way of another example, the garter spring 206 may be made of a steel material.

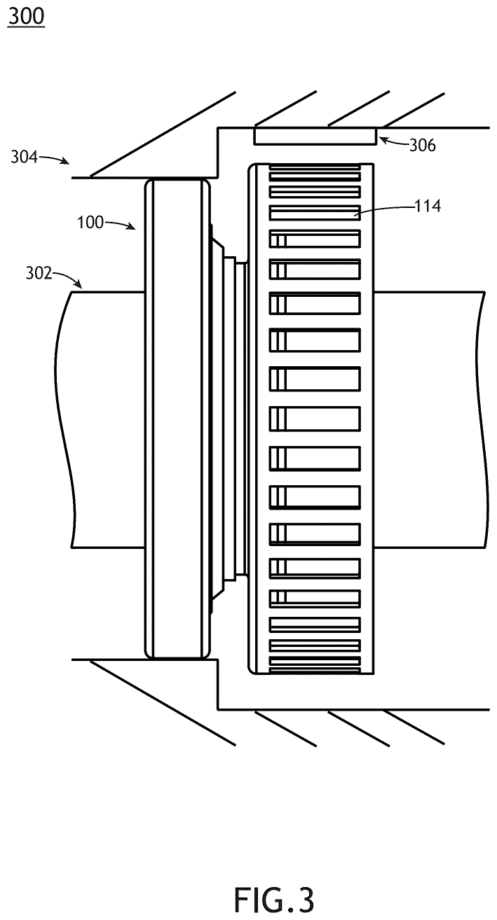

FIG. 3 depicts an axle assembly 300, in accordance with one or more embodiments of the present disclosure. The axle assembly 300 may include the sealing device 100, an axle shaft 302, an axle housing 304, and/or a sensor 306.

The sealing device 100 and the axle shaft 302 may be coupled. For example, the over-mold chamfer 104 may be coupled to an outer diameter of the axle shaft 302. The sealing device 100 and the axle shaft 302 may be coupled by a press-fit (e.g., an interference fit). The ribs 120 of the over-mold chamfer 104 may deform to seal the sealing device 100 to the axle shaft 302. The over-mold chamfer 104 may assist with assembling the sealing device 100 on the axle shaft 302 and/or reduce damage to the lip seal 106. For example, the axle shaft 302 may be inserted through the sealing device 100 via the mold chamfered portion 118. The sealing device 100 and the axle shaft 302 may rotate together.

The lip seal 106 may seal the axle shaft 302 to the axle housing 304. For example, the lip seal 106 may prevent fluid from flowing axially through the lip seal 106.

The axle housing 304 may house the axle shaft 302 and/or the sealing device 100. The sensor 306 may be coupled to the axle housing 304. The sensor 306 may be disposed radially outwards of and axially aligned with the axial slots 114. The sensor 306 may sense the rotation of the axle shaft 302 via the axial slots 114. The tone wheel 102 may be a ferromagnetic material to enable the sensor 306 to sense the axial slots 114. The sealing device 100 may be a cost-effective and serviceable method for sensing the rotation of the axle shaft 302.

The axle shaft 302 may be an axle shaft of a vehicle. For example, the axle shaft 302 may be coupled to a wheel (not depicted) of the vehicle. The rotation of the axle shaft 302 may correspond to a wheel speed of a wheel coupled to the axle shaft 302. Thus, the sensor 306 may sense the wheel speed. The sensor 306 may provide the wheel speed for controlling an anti-lock brake system, a traction control system, or the like. The configuration of the axle assembly 300 may package the tone wheel 102 inboard of the wheels of the vehicle. The sealing device 100 may reduce difficulties and costs associated with packaging the tone wheel 102 inboard of the wheels of the vehicle.

The term “axial” and derivatives thereof, such as “axially,” shall be understood to refer to a direction along the axis of rotation. Further, the term “radial” and derivatives thereof, such as “radially,” shall be understood in relation to the axis. For example, “radially outwards” refers to further away from the axis, while “radially inwards” refers to nearer to the axis. The term “circumferential” and derivatives thereof, such as “circumferentially,” shall be understood in a circumference at a fixed radius in relation to the axis.

One skilled in the art will recognize that the herein described components operations, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components, operations, devices, and objects should not be taken as limiting.

As used herein, directional terms such as “top,” “bottom,” “over,” “under,” “upper,” “upward,” “lower,” “down,” and “downward” are intended to provide relative positions for purposes of description, and are not intended to designate an absolute frame of reference. Various modifications to the described embodiments will be apparent to those with skill in the art, and the general principles defined herein may be applied to other embodiments

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. As such, to the extent any embodiments are described as less desirable than other embodiments or prior art implementations with respect to one or more characteristics, these embodiments are not outside the scope of the disclosure and can be desirable for particular applications.

### LIST OF REFERENCE NUMBERS

100 Sealing Device
102 Tone Wheel
104 Over-Mold Chamfer
106 Lip Seal
108 Wheel Inner Axial Portion
110 Wheel Radial Portion
112 Wheel Outer Axial Portion
114 Axial Slots
116 Mold Ribbed Portion
118 Mold Chamfered Portion
120 Ribs
202 Outer Ring
204 Spring Gasket
206 Garter Spring
208 Carrier
210 Carrier Gasket
212 Insert
214 Carrier Inner Axial Portion
216 Carrier Inner Radial Portion
218 Carrier Outer Axial Portion
220 Carrier Outer Radial Portion
222 Seal Radial Portion
224 Seal First Lip Portion
226 Seal Second Lip Portion
228 Ring Inner Radial Portion
230 Ring Axial Portion
232 Ring Outer Radial Portion
234 Insert Axial Portion
236 Insert Radial Portion
300 Axle Assembly
302 Axle Shaft
304 Axle Housing
306 Sensor

What is claimed:

1. A sealing device comprising:
a tone wheel comprising a wheel inner axial portion, a wheel radial portion, and a wheel outer axial portion, wherein the wheel radial portion couples between the wheel inner axial portion and the wheel outer axial portion, wherein the wheel inner axial portion and the wheel outer axial portion axially extend from the wheel radial portion in opposing directions, wherein the wheel outer axial portion defines a plurality of axial slots;
an over-mold chamfer, wherein the over-mold chamfer is coupled to the wheel inner axial portion and the wheel radial portion; and
a lip seal, wherein the wheel inner axial portion is coupled to the lip seal, wherein the wheel inner axial portion is disposed radially inwards of and axially aligned with the lip seal.

2. The sealing device of claim 1, wherein the tone wheel, the over-mold chamfer, and the lip seal are coincident.

3. The sealing device of claim 1, wherein the plurality of axial slots are defined in a polar array.

4. The sealing device of claim 1, wherein the over-mold chamfer comprises a mold ribbed portion and a mold chamfered portion, wherein the mold ribbed portion couples to the wheel inner axial portion, wherein the mold chamfered portion couples to the wheel radial portion.

5. The sealing device of claim 4, wherein the mold ribbed portion is disposed radially inwards of and axially aligned with the wheel inner axial portion.

6. The sealing device of claim 4, wherein the mold chamfered portion is radially aligned with and disposed axially offset from the wheel radial portion, wherein the mold chamfered portion is disposed radially inwards of and axially aligned with the wheel outer axial portion.

7. The sealing device of claim 4, wherein the mold ribbed portion comprises a plurality of ribs, wherein the plurality of ribs are circumferentially revolved.

8. The sealing device of claim 4, wherein the mold chamfered portion flares radially outwards along an axial length of the mold chamfered portion away from the mold ribbed portion.

9. The sealing device of claim 1, wherein the wheel outer axial portion is disposed radially outwards of and axially offset from the lip seal.

10. The sealing device of claim 1, wherein the tone wheel comprises a ferromagnetic material.

11. The sealing device of claim 1, wherein the lip seal comprises:
an outer ring;
a carrier, wherein the carrier couples the lip seal to the tone wheel;
a garter spring;
a spring gasket, wherein the garter spring is coupled to the spring gasket, wherein the spring gasket seals the outer ring and the carrier;
a carrier gasket, wherein the carrier gasket seals the outer ring and the carrier; and
an insert, wherein the carrier and the carrier gasket are configured to axially translate between the outer ring and the insert, wherein the lip seal is a dynamic seal.

12. The sealing device of claim 11, wherein the outer ring, the spring gasket, the garter spring, the carrier, the carrier gasket, and the insert are coincident.

13. The sealing device of claim 11, wherein the outer ring comprises a ring inner radial portion, a ring axial portion, and a ring outer radial portion, wherein the ring inner radial portion and the ring outer radial portion extend radially inwards from opposing ends of the ring axial portion;
wherein the carrier comprises a carrier inner axial portion, a carrier inner radial portion, a carrier outer axial portion, and a carrier outer radial portion, wherein the carrier inner axial portion and the carrier outer axial portion axially extend in a same direction from opposing ends of the carrier inner radial portion, wherein the carrier inner radial portion and the carrier outer radial portion radially extend in opposing directions from opposing ends of the carrier outer axial portion;
wherein the spring gasket comprises a seal radial portion and a seal first lip portion.

14. The sealing device of claim 13, wherein the garter spring causes the seal first lip portion to seal to the carrier inner axial portion, wherein the spring gasket couples between the ring inner radial portion and the carrier inner axial portion.

15. The sealing device of claim 13, wherein the spring gasket, the garter spring, the carrier, the carrier gasket, and the insert are disposed radially inwards of the ring axial portion, wherein the insert is radially aligned with and axially disposed between the carrier gasket and the ring inner radial portion.

16. The sealing device of claim 13, wherein the insert comprises an insert axial portion and an insert radial portion, wherein the insert radial portion extends radially inwards from the insert axial portion, wherein the insert axial portion is configured to abut the ring inner radial portion, wherein the insert radial portion is configured to abut the carrier gasket.

17. An axle assembly comprising:
a sealing device comprising:
a tone wheel comprising a wheel inner axial portion, a wheel radial portion, and a wheel outer axial portion, wherein the wheel radial portion couples between the wheel inner axial portion and the wheel outer axial portion, wherein the wheel inner axial portion and the wheel outer axial portion axially extend from the wheel radial portion in opposing directions, wherein the wheel outer axial portion defines a plurality of axial slots;
an over-mold chamfer, wherein the over-mold chamfer is coupled to the wheel inner axial portion and the wheel radial portion; and
a lip seal, wherein the wheel inner axial portion is coupled to the lip seal, wherein the wheel inner axial portion is disposed radially inwards of and axially aligned with the lip seal;
an axle shaft, wherein the over-mold chamfer is coupled to an outer diameter of the axle shaft;
an axle housing, wherein the lip seal seals the axle shaft to the axle housing; and
a sensor, wherein the sensor is coupled to the axle housing, wherein the sensor is disposed radially outwards of and axially aligned with the plurality of axial slots, wherein the sensor is configured to sense rotation of the axle shaft via the plurality of axial slots.

18. The axle assembly of claim 17, wherein the over-mold chamfer comprises a mold ribbed portion and a mold chamfered portion, wherein the mold ribbed portion couples to the wheel inner axial portion, wherein the mold chamfered portion couples to the wheel radial portion.

19. The axle assembly of claim 18, wherein the mold ribbed portion comprises a plurality of ribs, wherein the plurality of ribs are circumferentially revolved;
wherein the plurality of ribs deform to seal the sealing device to the axle shaft.

20. A lip seal comprising:
an outer ring, wherein the outer ring comprises a ring inner radial portion, a ring axial portion, and a ring outer radial portion, wherein the ring inner radial portion and the ring outer radial portion extend radially inwards from opposing ends of the ring axial portion;
a carrier, wherein the carrier comprises a carrier inner axial portion, a carrier inner radial portion, a carrier outer axial portion, and a carrier outer radial portion, wherein the carrier inner axial portion and the carrier outer axial portion axially extend in a same direction from opposing ends of the carrier inner radial portion, wherein the carrier inner radial portion and the carrier outer radial portion radially extend in opposing directions from opposing ends of the carrier outer axial portion;
a garter spring;
a spring gasket, wherein the garter spring is coupled to the spring gasket, wherein the spring gasket seals the outer ring and the carrier, wherein the spring gasket comprises a seal radial portion and a seal first lip portion;
a carrier gasket, wherein the carrier gasket seals the outer ring and the carrier; and
an insert, wherein the carrier and the carrier gasket are configured to axially translate between the outer ring and the insert, wherein the lip seal is a dynamic seal.
